(19) United States
(12) Patent Application Publication
(10) Pub. No.: US 2014/0122860 A1
(43) Pub. Date: May 1, 2014

(54) CLOUD SYSTEM AND BOOT DEPLOYMENT METHOD FOR THE CLOUD SYSTEM

(71) Applicant: DELTA ELECTRONICS, INC., Taoyuan County (TW)

(72) Inventors: Ben-Chiao JAI, Taoyuan County (TW); Wen-Min HUANG, Taoyuan County (TW); Pa HSUAN, Taoyuan County (TW); Yen-Fu CHEN, Taoyuan County (TW)

(73) Assignee: DELTA ELECTRONICS, INC., Taoyuan County (TW)

(21) Appl. No.: 14/049,442

(22) Filed: Oct. 9, 2013

(30) Foreign Application Priority Data
Oct. 26, 2012 (CN) 201210415414.1

(51) Int. Cl. G06F 9/44

(52) U.S. Cl. CPC G06F 9/4416
USPC 713/2

(57) ABSTRACT

A cloud system and boot deployment method is provided to offer flexible and rapid host allocation and operating environment deployment. The cloud system comprises a boot server, a storage machine and a host. The required data for the boot deployment procedure is saved in the storage machine in advance. When the host is assigned the boot operation, a user makes a boot request via the management interface of the boot server to the host. The boot server sets up or transfers the file system according to user request and accesses corresponding images and root file system in the storage machine for performing the boot deployment procedure on the host. When there are different application service requests, the boot server respectively applied shared or proprietary images and root file systems for executing boot deployment operations according to each application request.

### BACKGROUND OF THE INVENTION

1. Field of the Invention

The present invention relates to a cloud system, in particular relates to a boot deployment method for a cloud system.

2. Description of Related Art

Generally speaking, a cloud system uses a boot server to connect to several physical machines (PMs), the boot server performs operating system installation, and host boot operation on PMs connected to the boot server via the standard Preboot eXecution Environment (PXE) procedure.

According to the current methods, generally a boot server simultaneously corresponds to several PMs. The required images of operating system installation, configuration of each PM, and replied data of each PM are saved in the boot server, which means the data is overly centralized.

When the boot server fails, the operations of the cloud system is at risk. The images and configuration are all saved in the internal hard drive in the boot server. It is inconvenient to administrators when perform image and configuration updating, adding or deleting tasks.

In addition, only one kind of operating system can be deployed when network boot is launched through ordinary bootstrapping method. If there are several operating systems used in a cloud datacenter, the administrators are required to logon to the boot server and manually change the configuration of each PM such that the corresponding PMs access correct root file systems.

Additionally, if a PM fails and is replaced, the configuration of the PM in the boot server has to be changed such that the new PM can operate normally. Therefore, it is desired to provide an automation method to reduce the system operation loading.

### SUMMARY OF THE INVENTION

The objective of the present invention is to provide a cloud system and a boot deployment method for a cloud system, which are used for executing boot deployment operations on a cloud host using corresponding images and root file system according requirements of the cloud host. In order to achieve the objective, the cloud system of the present invention comprises a boot server, and a storage machine the boot server connected to, and a host which the boot server connected to. The user writes a plurality of images and root file system required by the boot deployment procedure in storage machine in advance. When the host is assigned the boot operation, the user makes a boot request to the host via the management interface of the boot server. The boot server accesses corresponding images and root file system in the storage machine for performing the boot deployment procedure on the host according to required configuration of the user.

Compare to related art, the present invention provides the advantage in that one or several images and root file systems required by the boot task are stored in the storage machine, the corresponding images and root file systems are used according to the boot task requirement of the host, configured by the administrators for performing the boot deployment procedure of the host. Thus, the problem is to overcome where a system is allowed to deploy the same operating system of all hosts during booting when using traditional means for performing network boot with bootstrapping.

With the present invention, a plurality of hosts in the cloud datacenter is respectively assigned different boot operations; it is convenient to the administrators that they do not need to repetitively update the configuration in the boot server to meet different deployment requirements of a plurality of hosts.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic chart of system architecture of a preferred embodiment according to the present invention;

FIG. 2 is a system block diagram of a preferred embodiment according to the present invention;

FIG. 3 is a file installation flowchart of a preferred embodiment according to the present invention;

FIG. 4 is a boot deployment flowchart of a preferred embodiment according to the present invention;

FIG. 5A is a boot deployment flowchart of another preferred embodiment according to the present invention;

FIG. 5B is a boot deployment flowchart of the other preferred embodiment according to the present invention;

FIG. 6 is a boot deployment flowchart of still another preferred embodiment according to the present invention;

FIG. 7 is a system block diagram of another preferred embodiment according to the present invention; and

FIG. 8 is a system block diagram of still another preferred embodiment according to the present invention.

### DETAILED DESCRIPTION OF THE INVENTION

Embodiments are provided in the following in order to further detail the implementations of the present invention in the summary. It should be noted that objects used in the diagrams of the embodiments are provided with proportions, dimensions, deformations, displacements and details are examples and the present invention is not limited thereto and identical components in the embodiments are the given same component numbers.

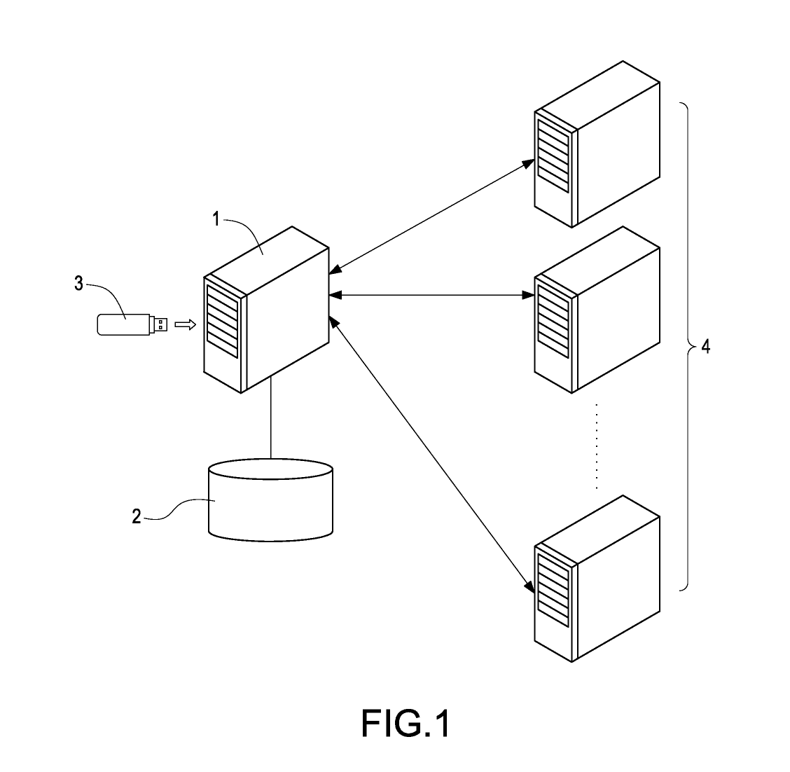

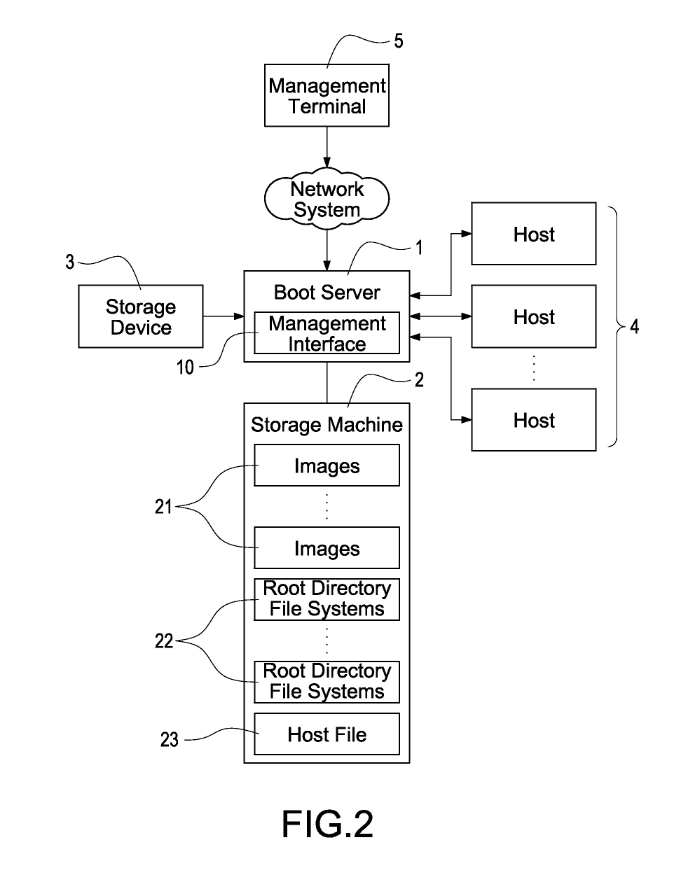

FIG. 1 and FIG. 2 are schematic chart of system architecture and a system block diagram of a preferred embodiment according to the present invention. The cloud system of the present invention comprises a boot server 1, a storage machine 2 connecting to network and one or more than one cloud hosts (mainly are physical machines (PMs) of the cloud system, referred as the host 4 in the following description). The plurality of host 4 is a blank server in the cloud datacenter. The boot server 1 connects to the host 4 for executing a boot deployment procedure via the boot server 1. In the embodiment, each host 4 connects to the boot server 1 via the network. Further, if each host 4 and the boot server 1 are installed in same rack or the same cloud datacenter, each host 4 also physically connects to the boot server 1 via the switch, and is not limited thereto.

After the boot deployment procedure is executed, each host 4 is respectively installed with required operating systems (OS, such as Win XP, Win 7, Linux etc.). Each host is deployed by the boot server according to the deployment configuration, and is ready to directly perform corresponding roles in the cloud datacenter, such as a computing node, storage node etc. It should be noted that the specific operating system to install and the specific deployment configuration to perform which each host 4 respectively requires depend on the boot operation assigned by the administrators and are not subject to the decision of each host.

In the embodiment, the boot server 1 connects to a storage device 3. The storage device 3 is a plug and play hard drive, universal serial bus (USB) drive or Disk On Module (DOM) etc. The storage device 3 stores the main contents required for the boot. The boot server 1 is used for performing the boot deployment procedure of the host 4. The required data for the boot and deployment are not saved in the boot server 1. Thus, even the boot server 1 fails, the operations of the whole cloud system is not at risk.

When the boot server 1 connects to the storage device 3, a plurality of images 21 and root file system 22 related to OS volume in the storage device 3 are added to the storage machine 2. The plurality of images 21 and root file system 22 respectively corresponds to different operating systems in order to meet different requirements of administrators. For example, the storage device 3 is pre-installed with at least four images 21, wherein the first image is used for installation and deployment of Windows XP operating system, the second image is used for installation and deployment of Windows 7 operating system, the third image is used for installation and deployment of Windows 8 operating system, and the fourth is used for installation and deployment of Linux operating system. A plurality of the root file systems 22 are determined by the boot operation assigned to each host 4 by the administrators, the boot server 1 provides the corresponding root file system 22 to the host 4 such that the hosts 4 are allowed to execute the assigned the boot operations. The above descriptions are preferred embodiments of the present invention and are not limited thereto.

It should be noted that in the present invention, the storage machine 2 is a Network Attached Storage (NAS) or a Distributed File System (DFS) constituted by a system volume, and physically connected to the boot server 1 via a cable or a network, but is not limited thereto.

Upon the host 4 is activated, the boot server 1 sends a boot request, the boot server 1 is informed of the operating system demanded by the host making the boot request according to the configurations of the administrators. Finally, the boot server 1 accesses the image of the operating system and the root file system 22 required by the host 4 from the storage machine 2. After the data access is completed, the boot server 1 executes the boot deployment procedure on the host 4 via the corresponding image 21 and the root file system 22. Thus, when the boot deployment procedure is successfully executed, the host 4 is immediately activated or installed the required operating system, complete corresponding deployment, and ready to serve the assigned role in the cloud system.

In the embodiment, the storage device 3 comprises a plurality of OS volumes. When the storage device 3 connects to the boot server 1, the boot server 1 saves OS volume (comprising several images 21 and several the root file systems 22) of the storage device 3 in the storage machine 2 for updating OS volumes of the storage machine 2. The OS volumes are used for saving OS volume related to OS (i.e., the images 21 and the root file systems 22).

In another embodiment, the system transfers the latest OS volume (i.e., new OS volume) to the storage machine 2 via other method, for example transferring directly via a network for updating the images 21 and the root file systems 22 in the storage machine 2. Thus, the boot server 1 executes the boot deployment procedure according to new OS volume. In another embodiment, the system provides a web interface (not shown in the diagrams) to operate by the administrators. Thus, administrators directly uploads the OS volume to update in the storage machine 2 via the web interface for updating the images 21 and the root file systems 22 of the storage machine 2 and are not limited thereto.

As mentioned above, the system saves the images 21 and the root file systems 22 via the storage device 3 or the web. When the administrators consider it is required to perform updates or changes of the OS volumes in the storage machine 2, the only step is to replace the storage device 3, or connects to a specific updating server (not shown in the diagrams) via the web. Under the circumstance, the administrators do not need to logon the boot server 1, and manually updating various configurations in the boot server 1, neither need to replace the installed hard drive in the boot server 1 (because the images 21 and the root file systems 22 are not in the boot server 1). Thus the administrators are able to conveniently and rapidly update the system OS volume used by the system.

In the embodiment, when the storage device 3 is replaced, and the new storage device connects to the boot server 1, an updating procedure is automatically executed. In further details, the images and/or root file system stored in the new the storage device 3 are copied to the storage machine 2 and new OS volume are installed in the storage machine 2. Accordingly, when the administrators consider it is required to perform updates or changes of OS volume in the storage machine 2. The administrators do not need to manually change or configure the storage machine 2. The only step required is to replace the storage device 3, which is convenient. It should be noted that when there are some OS volumes in the storage machine 2 to delete, the users have to logon to the boot server 1 via a management interface 10 in order to delete the OS volumes in the storage machine 2. The OS volumes are not overwritten by the updating procedure and the history records are reserved accordingly.

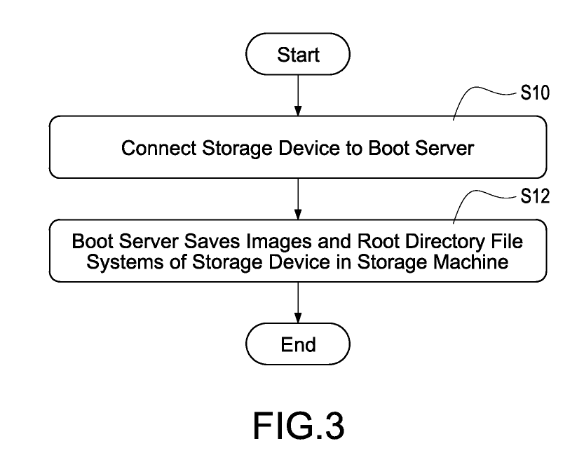

FIG. 3 is a file installation flowchart of a preferred embodiment according to the present invention, where the boot deployment method of a cloud host is executed. First, the administrators connect the storage device 3 to the boot server 1 (step S10) for example the storage device 3 is plugged in to connection port (such as a USB, 1394, e-SATA port etc. and are not limited thereto) of the boot server 1. Next, the boot server 1 automatically saves the images 21 and the root file systems 22 of the storage device 3 in the storage machine 2 (step S14). As mentioned above, the images 21 respectively correspond to different operating system. After the step S14, the boot server 1 is ready to receive the boot requests from each host 4 after the host 4 is activated, access corresponding the images 21 and the root file systems 22 in the storage machine 2 according to administrators requirements configured by each host 4, and further execute the boot deployment procedure on each host 4.

As shown in the FIG. 1, the boot server 1 provides the management interface 10 used for receiving the external operations from the administrators in order to respectively configure a demand table of each host. The demand tables are stored in the boot server 1, and record content of boot operation, for example the kinds of operating system to install/execute, the parameters to configure etc. assigned to each host 4 by the administrators. After the administrators assign the boot operations to each host 4, the demand tables configured by the administrators are transferred respectively to each host 4 by the boot server 1. Thus, after each host 4 is activated, the boot server 1 executes the assigned boot operation according to the demand table.

Substantially, the administrators respectively configure the contents of the boot operation of each host 4 via the management interface 10, such as the operation systems to install/execute, the role parameters to configure, and the contents to deploy etc., and the data is recorded in the demand tables. Thus, after each host 4 is activated, the assigned boot operation is executed according to the demand table. After receiving the boot requests of the host 4, the boot server 1 accesses the images 21 and the root file system 22 required by the boot operations as recorded in the demand table so as to assure the requirements of the each host 4 configured by the administrators are implemented. The advantage is that the boot server 1 is allowed to service several hosts 4 at one time. Even the operating systems and deployment configuration of the hosts 4 are different, the boot server 1 respectively understand and satisfy the content of boot operation assigned to the hosts 4 according to the demand table configured by the administrators.

In the embodiment, it should be noted that the management interface 10 is a web-based user interface (UI) or command line interface (CLI), the administrators logon to the management interface 10 via the web and operates on the boot server 1 via the management interface 10, and configure the requirements on the host 4. Further, as shown in FIG. 1, the system of the present invention further comprises a management terminal 5 connecting to the boot server 1 via the web system. Thus, the administrators operate on the management terminal 5 to connect to the web, and logon to use the management interface 10. In the embodiment, the management terminal 5 is a desktop computer, a notebook computer or a tablet which connects to the web via wired or wireless transmission interface to logon to the management interface 10, but is not limited thereto.

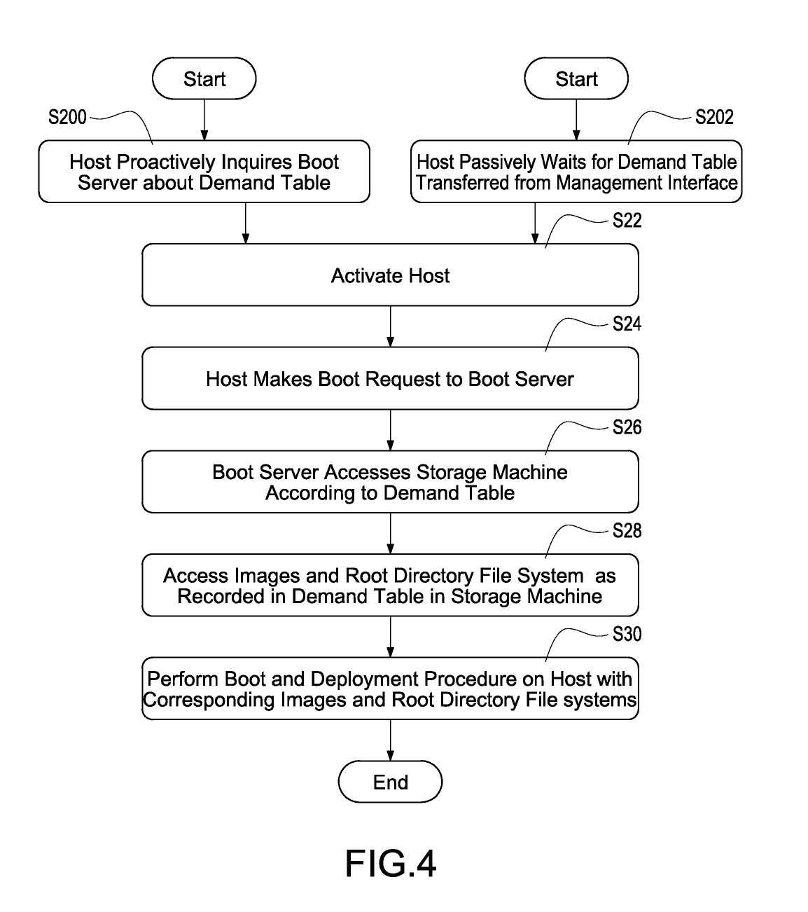

FIG. 4 is a boot deployment flowchart of a preferred embodiment according to the present invention. As shown in the diagram, each host in the system proactively inquires the boot server 1 about the demand table related to the boot deployment procedure (step S200). Or, each host 4 passively waits for the demand table transferred from the management interface 10 (step S202). For example, the administrators periodically logon to the management interface 10 for configuring and transfer the demand table to each host 4. If each host 4 is not configured, and does not receive the demand table after waiting for a predetermined time, each host 4 proactively inquire the boot server 1. The advantage is that the host assigned the boot operation has access to the demand table.

After the step S200 or S202, the host 4 has the demand table configured by the administrators. After the host 4 is activated, the assigned boot operation is executed according to the demand table. After the host 4 is activated, (step S22), the next step is making the boot request to the boot server 1 (step S24) so as to make a request to the boot server 1 for performing the boot. It should be noted that, in the step S22, the administrators press the power-on button of the host 4 (not shown in the diagrams) for activating the host 4. Or, the administrators logon to the management interface 10, execute the wake-on-lan (WOL) via the management interface 10 for activating the host 4 online. The advantage is that the administrators do not need to go to the cloud datacenter where the hosts 4 are installed in person and are allowed to activate the hosts 4 anywhere.

The boot server 1 receives the boot request and is informed of the requirement of the host 4 according to the demand table configured by the administrators. Further, the boot server 1 accesses the storage machine 2 according to the requirements of the host 4 (step S26) and accesses the images 21 and the root file systems 22 required by the boot operation as recorded in the demand table in the storage machine 2 (step S28). For example, many images 21 are stored in the storage machine 2, but the boot server 1 only accesses the images related to the boot operation assigned to the host 4. Other irrelevant images are not accessed. At last, the boot server 1 performs the boot deployment procedure on the host 4 with the corresponding the images 21 and the root file systems 22 (step S30).

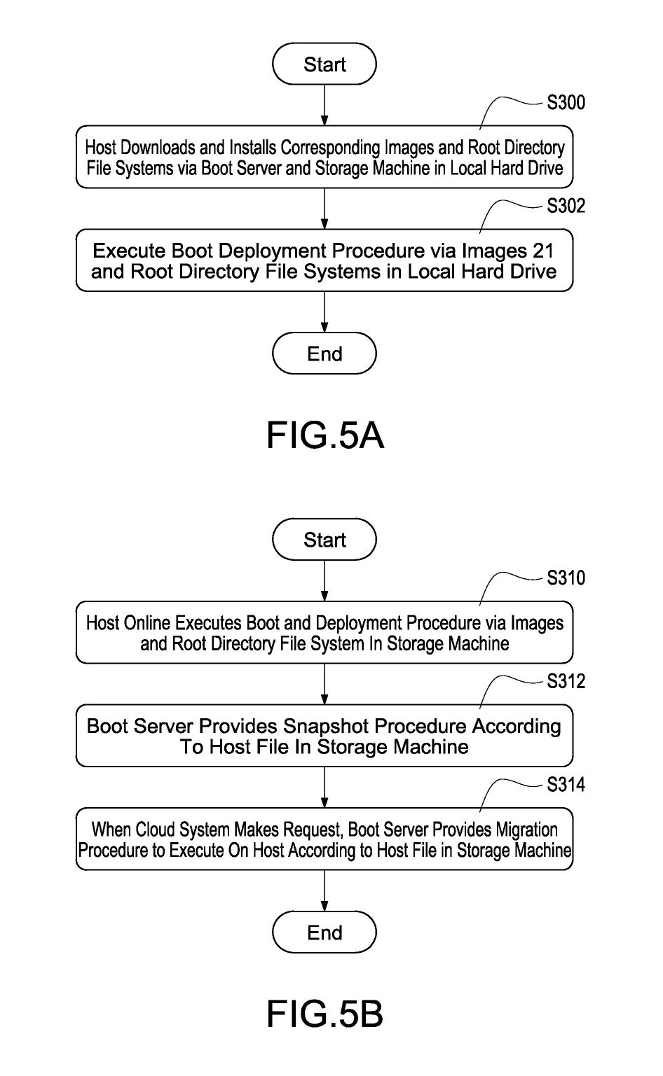

FIG. 5A and 5B are boot deployment flowcharts of another and still another preferred embodiment according to the present invention. As shown in the FIG. 5A, in the step S30, the host 4 downloads and installs the corresponding the images 21 and the root file systems 22 via the boot server 1 and the storage machine 2, in the local hard drive of the host 4 (not shown in the diagrams) (step S300). Thus, the host 4 executes the boot deployment procedure via the images 21 and the root file systems 22 in the local hard drive (step S302). In the embodiment, the host 4 completes the boot deployment procedure, and then saves all the data in the local hard drive like a general personal computer. The difference is that the host 4 is a node in the cloud system for providing the cloud services.

As shown in FIG. 5B, in the step S30, the host 4 online executes the boot and deployment procedure directly via the images 21 and the root file system 22 in the storage machine 2 (step S310). The difference between the FIG. 5A and 5B is that in the embodiment illustrated in FIG. 5B, the host 4 saves a host file generated after the boot (as the host file 23 illustrated in the FIG. 1) in the storage machine 2. The advantage is that, in addition to the operating system of the host 4, all other data is saved in the storage machine 2 instead of the local hard drive of the host 4. When the host 4 fails or required to be replaced, the only step to perform by the system is providing a new blank host. Also, after the boot deployment procedure is executed, the host file 23 in the storage machine 2 is accessed for performing the system restore. Accordingly, the system is flexible to the administrators to operate and the cloud system further is more reliable.

Thus, as shown in FIG. 5B, when the cloud system makes the request, the boot server 1 provides a snapshot procedure to execute on the host 4 according to the host file 23 in the storage machine 2 (step S312). When the cloud system makes the request, the boot server 1 provides a migration procedure to execute on the host 4 according to the host file 23 in the storage machine 2 (step S314). The snapshot, mentioned above and migration procedure are related-art to people skilled in the art and are not elaborated in the description. The cloud system optionally executes the step S312 and/or the step S314 depending on the requirements, and it is not required to execute the step S312 and S314 by an order or at the same time, and is not limited thereto.

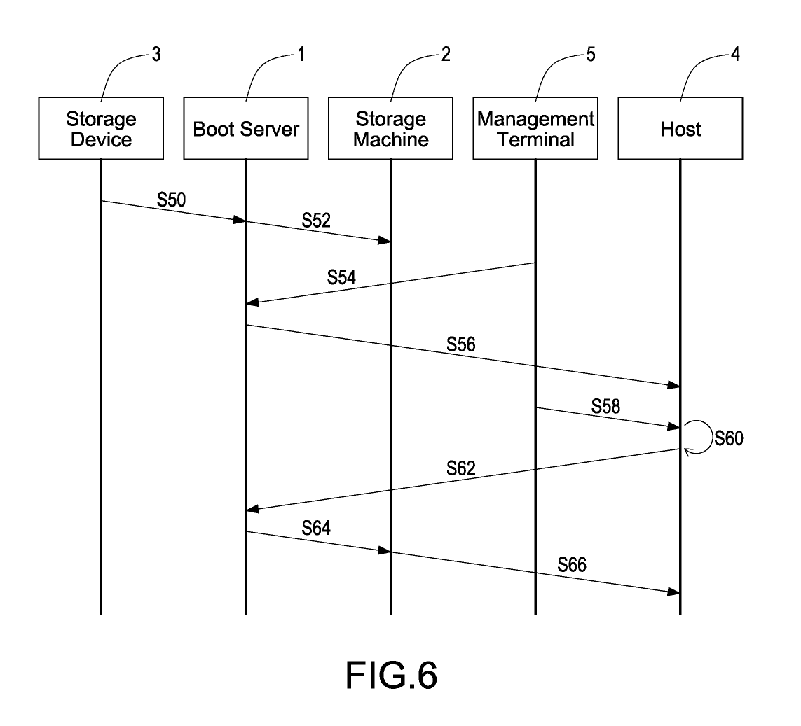

FIG. 6 is a boot deployment flowchart of still another preferred embodiment according to the present invention. FIG. 6 fully illustrates the executing order of the timing for the boot server 1, the storage machine 2, the storage device 3, the host 4, and the management terminal 5 in the system according to the present invention.

First, the administrators connect the storage device 3 to the boot server 1 (step S50). Next, the boot server 1 saves the plurality of images 21 and the plurality of root file systems 22 of the storage device 3 in the storage machine 2 (step S52). When the administrators assign a boot operation to the host 4, the boot server 1 is operated via the management interface 10 for configuring the demand table of the host 4 (step S54). Thus, the boot server 1 is informed that when the boot request of the host 4 is received, the required data for the boot deployment procedure is delivered to the host 4 and the boot server 1 transfers the demand table to the host 4 (step S56). Therefore, after the host 4 is activated, the assigned boot operation is executed according to the demand table.

When the boot operation is performed on the host 4, the administrators operate on the management terminal 5 to activate the host 4 via wake-on-lan (step S58). Or, the administrators directly press the power on button on the host 4 to activate the host (step S60). After the host 4 is activated, the host makes a boot request to the boot server 1 for booting the host 4 (step S62). It should be noted that the administrators configure the demand table, mentioned above via the management interface 10. Also, the demand table can be written to the storage device 3 in advance, the boot server 1 then accesses the demand table in the storage device 3, however, the scope of the present invention is not limited by above specific example.

The boot server 1 receives the boot request; the boot server 1 is informed of requirements of the host 4 according to the demand table configured by the administrators. Accordingly, the boot server 1 accesses the images 21 and the root file systems 22 required by the boot operation in the storage machine 2 as recorded in the demand table (step S64). Lastly, the boot server 1 executes the boot deployment procedure on the host 4 according to the images 21 and the root file systems 22 accessed (step S66). After the step S66, the host 4 immediately activates or finishes installing the required operating system, and completes the required deployment configuration so as to serve the role required by the system. In the step S66, the images 21 and the root file systems 22 recorded in the demand table are downloaded to the host 4 for performing OS installation, or directly activates the OS online via the storage machine 2, and are not limited thereto.

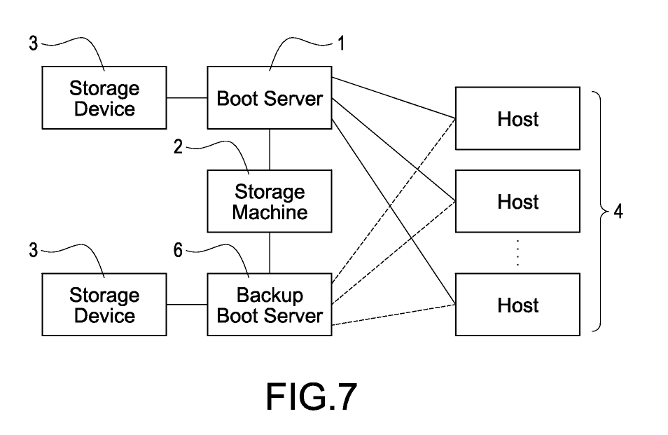

FIG. 7 is a system block diagram of another preferred embodiment according to the present invention. In the embodiment, the system further comprises a backup boot server 6. The backup boot server 6 connects to the storage machine 2 and the plurality of host 4 via physically connection or via internet/Ethernet. The backup boot server 6 and the boot server 1 are identical connecting to the storage device 3 and saving the plurality of images 21 and the plurality of root file systems 22 of the storage device 3 in the storage machine 2. The advantage is that when the boot server 1 fails, the backup boot server 6 receives the boot request of the host 4 after switching automatically by the cloud system or manually by the administrators, and executes the boot deployment procedure on the host 4. This method reduce the amount of data lost from the failed boot server 1.

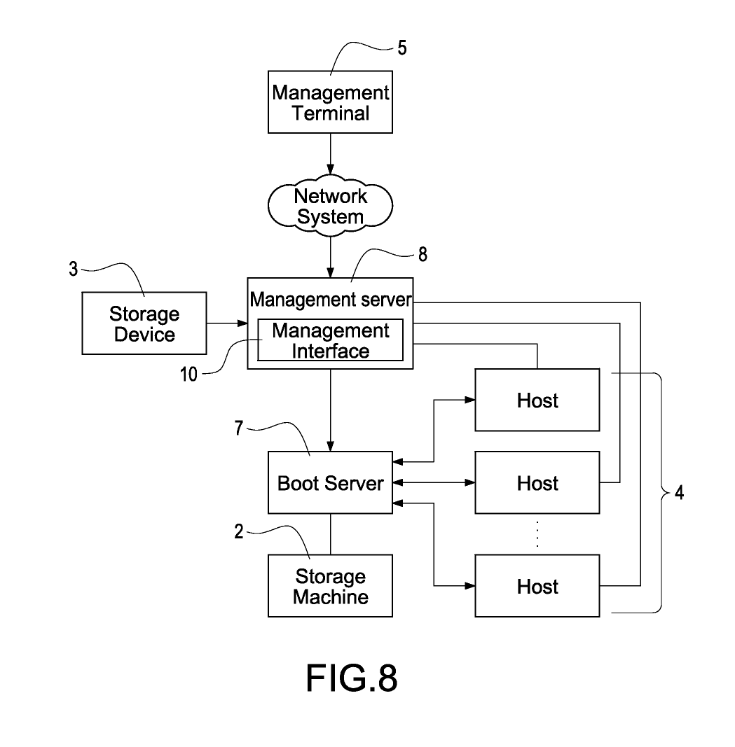

FIG. 8 is a system block diagram of still another preferred embodiment according to the present invention. FIG. 8 illustrates an independent management server 8 connects to a boot server 7 and the plurality of hosts 4 via physically connecting to the cable or the web. In the embodiment, the management interface 10 is installed and provided by the management server 8, the administrators operates on the management terminal 5 connecting to the management server 8 via the web system, and logon to the management interface 10 provided by the management server 8. Thus, the administrators operate on the management interface 10, configure and manage the boot server 1, configure each host 4 and transfer the demand table, and activate each host 4 via the wake-on-lan in order to execute the method of the present invention on each host 4.

As the skilled person will appreciate, various changes and modifications can be made to the described embodiments. It is intended to include all such variations, modifications and equivalents which fall within the scope of the invention, as defined in the accompanying claims.

What is claimed is:

1. A cloud system, comprising:
a boot server connecting to a storage device ;
a storage machine connecting to the boot server, saves operating system (OS) volume in the storage device via the boot server, wherein the OS volume comprises a plurality of images and a plurality of root file systems; and
a host, connecting to the boot server, making a boot request to the boot server for executing a boot deployment procedure via the boot server;
wherein, a pre-determined demand table is saved in the boot server, the demand table recording a content of boot operation assigned to the host, the boot server accessing the images and the root file system required by the boot operation from the storage machine according to the demand table for executing the boot deployment of the host.

2. The cloud system of claim 1, wherein the storage device is a hard drive, a USB drive or DOM (disk on module).

3. The cloud system of claim 1, wherein the storage machine is a system volume constituted by a network attached storage (NAS) or a distributed file system (DFS).

4. The cloud system of claim 1, wherein the boot server, the storage machine and the host are installed in the same rack in a cloud datacenter.

5. The cloud system of claim 1, wherein the boot server provides a management interface, the management interface receives external operating instructions for configuring the demand table for the host, saving the demand table in the boot server, and sending the demand table to the host.

6. The cloud system of claim 5, wherein the management interface is a web-based user interface (UI) or command line interface (CLI).

7. The cloud system of claim 6, wherein the cloud system further comprises a management terminal connecting to the boot server, the management terminal is operated by the administrators to logon and use the management interface.

8. The cloud system of claim 1, wherein further comprises a backup boot server connecting to the storage machine and the host, the backup boot server connects to the storage device, and saves the plurality of images and the plurality of root file system of the storage device in the storage machine, when the boot server is damaged, the backup boot server receives the boot request of the host and executes the boot deployment procedure on the host.

9. The cloud system of claim 1, wherein the storage machine receives the OS volume uploaded from a web or directly transferred via a network for updating the plurality of images and the plurality of root file system in the storage machine.

10. A boot deployment method of a cloud system for performing a boot deployment procedure on a host via a boot server in a cloud datacenter, the boot deployment method comprising:
a) activating the host;
b) the host making a boot request to the boot server;
c) the boot server accessing a storage machine in the cloud datacenter according to a pre-determined demand table, wherein the demand table records required images and a root file system a boot operation assigned to the host;
d) performing the boot deployment procedure on the host via the corresponding images and the root file system.

11. The boot deployment method of claim 10, further comprising following steps before the step a:
a0) the boot server connecting to a storage device; and
a1) saving a plurality of images and a plurality of root file systems of the storage device in the storage machine, wherein the plurality of images respectively correspond to different operating systems.

12. The boot deployment method of claim 11, wherein the boot server providing a management interface and the method further comprises a step e: the management interface receives external operating instructions for configuring the demand table for the host, saving the demand table in the boot server, and sending the demand table to the host.

13. The boot deployment method of claim 12, wherein in the step a, the management interface receives external operating instructions for activating the host by means of the wake-on-lan (WOL).

14. The boot deployment method of claim 11, wherein the step d further comprises the following steps:
d1) the host downloading the corresponding images and the root file system and installing the corresponding images and the root file system in a local storage device; and
d2) the host executing the boot deployment procedure via the images and the root file system in the local storage device.

15. The boot deployment method of claim 11, wherein the step d further comprising following steps:
d3) the host directly online executing the boot deployment procedure via corresponding the images and the root file system in the storage machine; and
d4) the hosts saving a host file generated after the boot in the storage machine.

16. The boot deployment method of claim 15, wherein further comprising following step:
f) the boot server providing the host executing a snapshot procedure according to the host file in the storage machine.
g) the boot server, providing the host executing a migration procedure according to the host file in the storage machine.

17. A cloud system comprising:
a boot server connecting to a storage device, a plurality of images and a plurality of root file system saved in the storage device, wherein the plurality of images respectively correspond to different operating systems;
a storage machine connecting to the boot server, the boot server saves the plurality of images and the plurality of root file system of the storage device in the storage machine;
a host connecting to the boot server; and
a management server, connecting to the boot server and the host, providing a web-based management interface, the management interface receives external operating instructions for configuring a demand table for the host and saving the demand table in the boot server, and transferring the demand table in the host, wherein the demand table records a content of boot operation assigned to the host;
wherein, after the host is activated, a boot request is made to the boot server, the boot server receives the boot request, the boot server accessing the images and the root file system required by the boot operation from the storage machine according to the demand table for executing the boot deployment of the host.

18. The cloud system of claim 17, wherein further comprises a backup boot server connecting to the storage machine and the host, the backup boot server connects to the storage device, and saves the plurality of images and the plurality of root file system of the storage device in the storage machine, when the boot server is damaged, the backup boot server receives the boot request of the host, and executing the boot deployment procedure on the host.

19. The cloud system of claim 17, wherein the storage device is a hard drive, an universal serial bus (USB) drive or disk on module (DOM), the storage machine is network attached storage (NAS) or a distributed file system (DFS) constituted by a system volume, and the boot server, the storage machine, the host and the management server are installed in the same rack in a cloud datacenter.

20. The cloud system of claim 17, wherein the management interface is a user interface (UI) or a command line interface (CLI).
